(19) United States
(12) Patent Application Publication
(10) Pub. No.: US 2018/0063879 A1
(43) Pub. Date: Mar. 1, 2018

(54) APPARATUS AND METHOD FOR INTEROPERATION BETWEEN INTERNET-OF-THINGS DEVICES

(71) Applicant: Electronics and Telecommunications Research Institute, Daejeon (KR)

(72) Inventor: Joo-Chul Lee, Daejeon (KR)

(73) Assignee: ELECTRONICS AND TELECOMMUNICATIONS RESEARCH INSTITUTE, Daejeon (KR)

(21) Appl. No.: 15/689,194

(22) Filed: Aug. 29, 2017

(30) Foreign Application Priority Data
Aug. 29, 2016 (KR) 10-2016-0110328
Jul. 25, 2017 (KR) 10-2017-0094121

(51) Int. Cl. H04W 76/02; H04W 48/16; H04W 4/00; H04L 29/08

(52) U.S. Cl. CPC H04W 76/026; H04W 48/16; H04W 4/18; H04W 76/023; H04L 67/1087; H04W 4/005

(57) ABSTRACT

Disclosed herein are an apparatus and method for interoperation between Internet-of-Things (IoT) devices. The IoT device interoperation method uses an IoT device interoperation apparatus and includes performing an endpoint discovery procedure between an Open Connectivity Foundation (OCF) device and a non-OCF Bluetooth Low Energy (BLE) device, and performing interoperation between the OCF device and the non-OCF BLE device by performing a resource manipulation procedure using a Create, Retrieve, Update, Delete, and Notify (CRUDN) operation.

### CROSS REFERENCE TO RELATED APPLICATIONS

This application claims the benefit of Korean Patent Application Nos. 10-2016-0110328, filed Aug. 29, 2016 and 10-2017-0094121, filed Jul. 25, 2017, which are hereby incorporated by reference in their entirety into this application.

### BACKGROUND OF THE INVENTION

### 1. Technical Field

The present invention relates generally to Internet-of-Things (IoT) technology and, more particularly, to technology for interoperation between an Open Connectivity Foundation (OCF) device and a Bluetooth Low Energy (BLE) device that does not support OCF.

### 2. Description of the Related Art

In the current market, platforms/frameworks for supporting the Internet of Things (IoT) in various manners coexist. Each platform emphasizes its own advantages to compete with other platforms for market share. Among these platforms, in Open Connectivity Foundation (OCF), various companies are participating in fixing related standards at the initiative of Samsung and Intel. Simultaneously therewith, IoTivity, which is an open-source project for implementing standards, is ongoing together with standardization.

IoTivity is an IoT open-source framework for realizing OCF standards, and is intended to support connections between respective devices independently of various Operating Systems (OSs) and communication protocols.

Bluetooth is protocol technology used to connect devices such as peripheral devices using frequencies in a 2.4 GHz band. With the advent of Bluetooth version 4.0, a Bluetooth Low Energy (BLE) function has been added, by which a basis for use with the IoT has been established. In IoT, BLE is a protocol that can be usefully utilized in wearable devices owing to characteristics such as low power consumption and low coverage.

Meanwhile, Korean Patent Application Publication No. 10-2014-0074152 entitled “Method and Mobile Terminal for Controlling BLE Device” discloses a method for, when a BLE device is registered, efficiently managing a Bluetooth Low Energy (BLE) device by indicating attribute information of the BLE device in a list and by registering information about the addition of a user to the BLE device, received from the user, to be mapped to the BLE device, and a mobile terminal for the method.

However, Korean Patent Application Publication No. 10-2014-0074152 is configured to manage a BLE device using a mobile terminal, and is disadvantageous in that, when a standard supported by an IoT device (e.g. mobile terminal) is not supported by the BLE device, configuration for interoperably connecting the IoT device to the BLE device is not taken into consideration.

### SUMMARY OF THE INVENTION

Accordingly, the present invention has been made keeping in mind the above problems occurring in the prior art, and an object of the present invention is to interoperably connect an OCF device that supports an OCF framework to an existing non-OCF BLE device that does not support the OCF framework.

Another object of the present invention is to allow a gateway for interoperation between an OCF device and a non-OCF BLE device to communicate with the non-OCF BLE device using the feature of a Generic ATTribute profile (GATT) when receiving a Representational State Transfer (REST) architectural style (i.e. RESTful) operation from the OCF device and to provide the results of communication with the non-OCF BLE device to the OCF device through a RESTful style operation.

In accordance with an aspect of the present invention to accomplish the above objects, there is provided an Internet-of-Things (IoT) device interoperation method using an IoT device interoperation apparatus, including performing an endpoint discovery procedure between an Open Connectivity Foundation (OCF) device and a non-OCF Bluetooth Low Energy (BLE) device; and performing interoperation between the OCF device and the non-OCF BLE device by performing a resource manipulation procedure using a Create, Retrieve, Update, Delete, and Notify (CRUDN) operation.

In accordance with another aspect of the present invention to accomplish the above objects, there is provided an Internet-of-Things (IoT) device interoperation apparatus, including an endpoint discovery unit for performing an endpoint discovery procedure between an Open Connectivity Foundation (OCF) device and a non-OCF Bluetooth Low Energy (BLE) device; a resource manipulation unit for performing interoperation between the OCF device and the non-OCF BLE device by performing a resource manipulation procedure on the non-OCF BLE device through a Create, Retrieve, Update, Delete, and Notify (CRUDN) operation in response to a request from the OCF device; and a resource model database (DB) unit for updating resource information in a resource model DB in response to a request from the endpoint discovery unit and/or the resource manipulation unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating an OCF framework of FIG. 1 according to an embodiment of the present invention;

FIG. 2 is a block diagram illustrating IoTivity architecture according to an embodiment of the present invention;

FIG. 3 is a diagram illustrating a BLE protocol stack according to an embodiment of the present invention;

FIG. 4 is a diagram illustrating the characteristic structure of a GATT service according to an embodiment of the present invention;

FIG. 5 is a diagram illustrating an IoT device interoperation system in which an OCF device and a non-OCF BLE device are interoperably connected to each other according to an embodiment of the present invention;

FIG. 6 is a block diagram illustrating an IoT device interoperation apparatus according to an embodiment of the present invention;

FIG. 7 is an operation flowchart illustrating an IoT device interoperation method according to an embodiment of the present invention;

FIG. 8 is an operation flowchart illustrating in detail an example of the endpoint discovery step illustrated in FIG. 7;

FIG. 9 is an operation flowchart illustrating in detail an example of the resource manipulation step illustrated in FIG. 7;

FIG. 10 is a sequence diagram illustrating an endpoint discovery method according to an embodiment of the present invention;

FIG. 11 is a sequence diagram illustrating another embodiment of the endpoint discovery method illustrated in FIG. 10;

FIG. 12 is a sequence diagram showing a CREATE operation performance method according to an embodiment of the present invention;

FIG. 13 is a sequence diagram showing a RETRIEVE operation performance method according to an embodiment of the present invention;

FIG. 14 is a sequence diagram showing an UPDATE operation performance method according to an embodiment of the present invention;

FIG. 15 is a sequence diagram showing a DELETE operation performance method according to an embodiment of the present invention;

FIG. 16 is a sequence diagram showing a NOTIFY operation performance method for activating notification setting according to an embodiment of the present invention;

FIG. 17 is a sequence diagram showing a NOTIFY operation performance method depending on the change of a characteristic value according to an embodiment of the present invention;

FIG. 18 is a sequence diagram showing a NOTIFY operation performance method for deactivating notification setting according to an embodiment of the present invention; and

FIG. 19 is a block diagram illustrating a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

In the present specification, it should be understood that the terms such as “include” or “have” are merely intended to indicate that features, numbers, steps, operations, components, parts, or combinations thereof are present, and are not intended to exclude a possibility that one or more other features, numbers, steps, operations, components, parts, or combinations thereof will be present or added.

Hereinafter, preferred embodiments of the present invention will be described in detail with reference to the attached drawings.

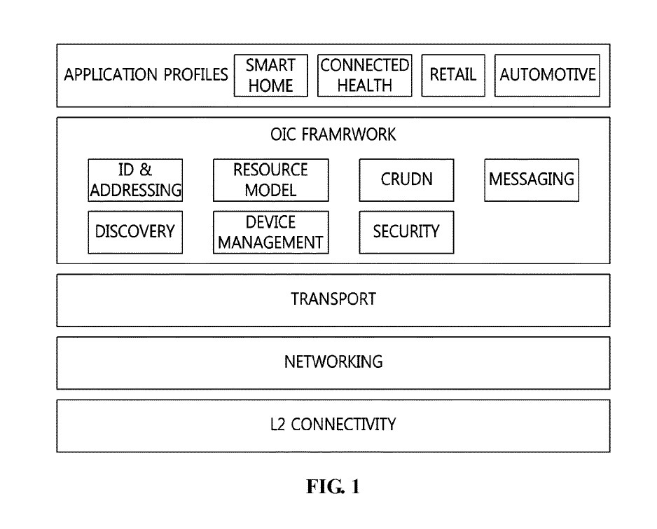

FIG. 1 is a diagram illustrating an OCF framework according to an embodiment of the present invention.

Referring to FIG. 1, it can be seen that the OCF framework according to the embodiment of the present invention may structure respective objects in a physical real world, constituting IoT, into resource models and then manage the resource models. In accordance with an embodiment of the present invention, the resource models may be processed as resource information. Here, Open Interconnect Consortium (OIC) was the early form of OCF, and the OCF prior to termination of interoperation with AllJoyn may also be referred to as “OIC”.

In functions for respective layers in the OCF framework illustrated in FIG. 1, an application profile layer may provide specific data models and common properties (Smart Home, Connected Health, Retail, and Automotive) depending on the service domain.

An OIC framework layer may provide functional interactions specified in the OIC core specification (ID & Addressing, Resource model, CREATE, RETRIEVE, UPDATE, DELETE, NOTIFY (CRUDN), Messaging, Discovery, Device management, and Security).

A transport layer may provide end-to-end flow communication suitable for Quality of Service (QoS) constraints.

A networking layer may provide a function for data exchange between OIC devices in a network.

An L2 connectivity layer may provide a connection function for the physical link layer (e.g. Wi-Fi or Bluetooth).

Further, interactions between individual objects may be realized via operations satisfying a RESTful style based on resource models.

That is, a RESTful operation may be composed of individual operations satisfying CRUDN.

Here, the RESTful operation may include at least one of CREATE, RETRIEVE, UPDATE, DELETE, and NOTIFY operations.

Here, the OCF client may be an entity that initiates communication in the RESTful operation, and may correspond to the OCF device according to an embodiment of the present invention.

Here, the OCF server may be an entity that responds to the communication initiated by the client, and may correspond to an IoT device interoperation apparatus according to an embodiment of the present invention.

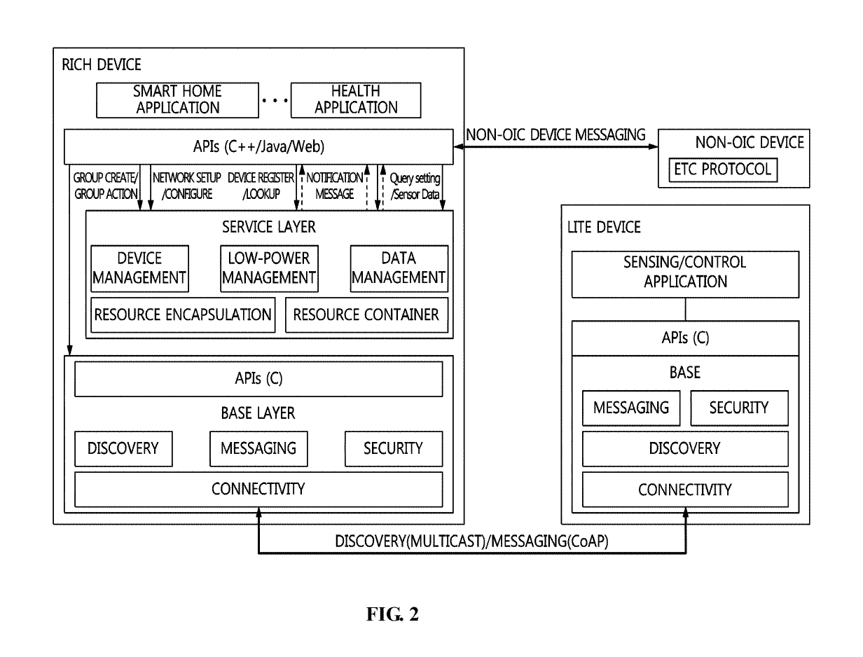

FIG. 2 is a block diagram illustrating IoTivity architecture according to an embodiment of the present invention.

Referring to FIG. 2, the IoTivity architecture according to an embodiment of the present invention may be divided into Rich devices and Lite devices depending on the type and performance of the device. Lite devices (e.g. Arduino) having limited capabilities may be equipped only with cores, and may provide only core Application Programming Interfaces (APIs) indicated by APIs(C). However, Rich devices may provide service APIs (i.e. APIs (C++/Java/Web)) provided via C++/Java, together with the core APIs (APIs(C)). The user may more easily develop applications using such a service API.

Further, the IoTivity architecture may use a Constrained Application Protocol (CoAP, RFC 7252), established by Internet Engineering Task Force (IETF), as a transport protocol. The CoAP may be a transport protocol specified for constrained devices having limited capabilities.

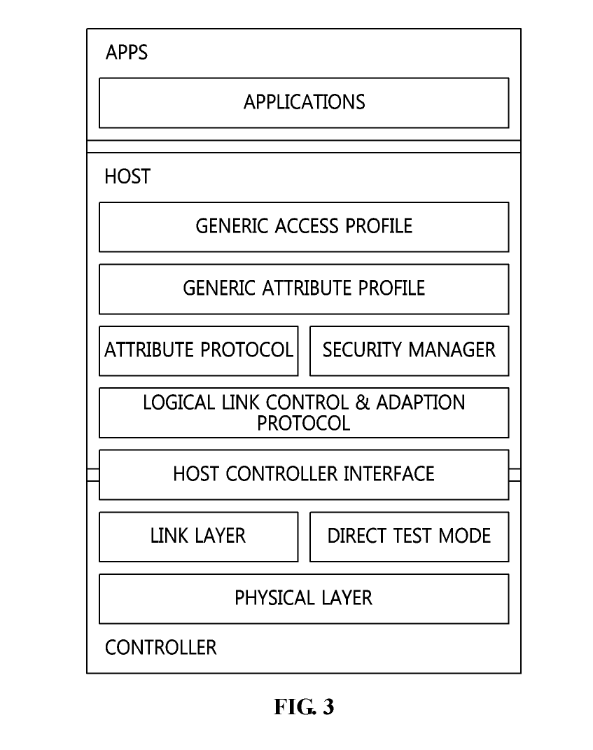

FIG. 3 is a diagram illustrating a BLE protocol stack according to an embodiment of the present invention.

Referring to FIG. 3, it can be seen that a BLE protocol stack according to an embodiment of the present invention includes an applications (APPS) region, a host region, and a controller region.

The APPS region may provide applications. The controller region may include a physical interface layer and a link layer. The host region may include a Logical Link Control & Adaptation Protocol (L2CAP) layer that supports packet encapsulation or partitioning/merging, a Generic ATTribute profile (GATT) that is concerned with data transmission in BLE, an ATTribute (ATT) protocol, a Generic Access Profile (GAP) that is used for the most basic control, such as the connection between BLE devices, and a Security Manager Protocol (SMP) that defines a pairing or key exchange method between devices. A Host Controller Interface (HCI) is present between the host region and the controller region, and may then provide a communication means between the host region and the controller region. In this case, when the host and the controller are implemented in a single chip, the HCI may be provided as a software (SW) API. When the controller is manufactured as a separate chip, the HCI may be a Universal Asynchronous Receiver/Transmitter (UART), a Serial Peripheral Interface (SPI), or a Universal Serial Bus (USB) interface.

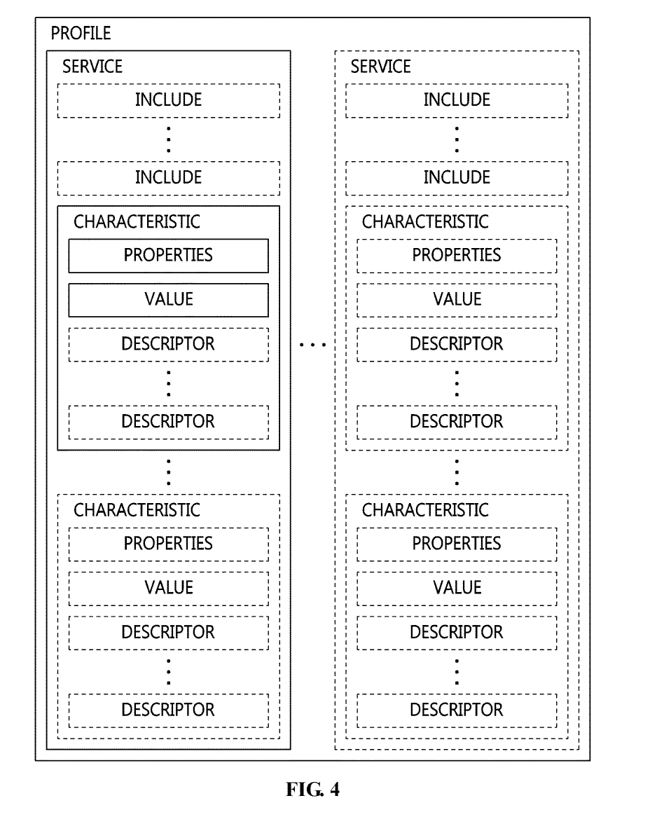

FIG. 4 is a diagram illustrating the characteristic structure of a Generic Attribute profile (GATT) service according to an embodiment of the present invention.

Referring to FIG. 4, in BLE data communication according to an embodiment of the present invention, GATT may provide a reference model that can be used by all other GATT-based profiles.

Here, the reference model may include a service characteristic model that represents data handled by BLE nodes.

Here, the reference model may define basic procedures required to exchange data. In GATT, the data to be exchanged by devices may be hierarchically represented. The actual data may be represented by characteristics, and characteristics may be collected to constitute a single service. GATT-based profiles for respective purposes, which are implemented based on the GATT, may define data that is used as characteristics, and related characteristics may be collected to constitute a single service.

Each characteristic may be composed of attributes.

Each attribute may be composed of the following fields.

Attribute=attribute handle+attribute type+attribute value+attribute permission

The attribute handle may correspond to a handle for identifying each attribute.

The attribute type may correspond to a type value (e.g. UUID is used) for identifying each attribute.

The attribute value may correspond to the actual value of each attribute.

The attribute permission may correspond to the operation permitted for each attribute.

Also, each characteristic may be defined by the following attributes.

Characteristic definition=characteristic declaration+characteristic value+(optional) characteristic descriptor(s)

In this way, the manipulation of characteristics constituting each service may be implemented using an ATT protocol. Services used in GATT-based profiles defined by a Bluetooth Special Interest Group (SIG), actual services, and formats and definition methods of respective characteristics are defined in detail in the Bluetooth core specification.

The ATT protocol may correspond to a communication protocol having a simple client/server structure. ATT may be used when an application that compiles with GATT-based profiles processes data.

Here, the data processed by the application may be attributes in GATT.

Here, examples of an ATT operation may provide the operations shown in the following Table 1.

TABLE 1

| Number | ATT operation type | Usage message |
|---|---|---|
| 1 | Error Handling | Error Response |
| 2 | Server Configuration | Exchange MTU Request/Response |
| 3 | Find information | Find Information Request/Response |
| | | Find by Type Value |
| 4 | Read operations | Read by Type Request/Response |
| | | Read Request/Response |
| | | Read Blob Request/Response |
| | | Read Multiple Request/Response |
| | | Read by Group Type Request/Response |
| 5 | Write operations | Write Request/Response |
| | | Write Command |
| | | Signed Write Command |
| 6 | Queued Writes | Prepare Write Request/Response |
| | | Execute Write Request/Response |
| 7 | Server Initiated | Handle Value Indication/Confirmation |
| | | Handle Value Notification |

Communication entities in the GATT may function as one of a client and a server, as in the case of ATT.

The client may be the client of the ATT, and may send a request to process an attribute to the server and receive a response to the request from the server.

The server may be the server of the ATT, and may receive a request for the attribute of the client, process the request, and send a response to the request to the client.

The GATT may support features shown in the following Table 2 so as to manipulate attributes. Respective features may be based on operations provided by the ATT. ATT operations to which sub-procedures of respective features are mapped may be given in the following Table 2.

The following Table 2 shows an example of a list of features supported by the GATT.

TABLE 2

| Num- | | | ATT |
|---|---|---|---|
| ber | Feature | Sub-procedure | operations |
| 1 | Server | Exchange MTU | Server |
| | Configuration | | Configuration |
| 2 | Primary | Discover All Primary Services | Read |
| | Service | Discover Primary Services by | Operations |
| | Discovery | service UUID | |
| 3 | Relationship | Find Included Services | Read |
| | Discovery | | Operations |
| 4 | Characteristic | Discover All Characteristics | Read |
| | Discovery | of a Service | Operations |
| | | Discover Characteristic by | |
| | | UUID | |
| 5 | Characteristic | Discover All Characteristic | Read |
| | Descriptor | Descriptors | Operations |
| | Discovery | | |
| 6 | Characteristic | Read Characteristic Value | Read |
| | Value Read | Read Using Characteristic UUID | Operations |
| | | Read Long Characteristic Values | |
| | | Read Multiple Characteristic | |
| | | Values | |
| 7 | Characteristic | Write Without Response | Read |
| | Value | Signed Write Without Response | Operations |
| | Notification | Write Characteristic Value | |
| | | Write Long Characteristic | |
| | | Values | |
| | | Characteristic Value Reliable | |
| | | Writes | |
| 8 | Characteristic | Notifications | Server |
| | Value | | Initiated |
| | Notification | | |
| 9 | Characteristic | Indications | Server |
| | Descriptor | | Initiated |
| | Value Read | | |
| 10 | Characteristic | Read Characteristic Descriptors | Read |
| | Descriptor | Read Long Characteristic | operations |
| | Value Read | Descriptors | |
| 11 | Characteristic | Write Characteristic Descriptors | Write |
| | Descriptor | Write Long Characteristic | operations |
| | Value Write | Descriptors | |

In BLE data communication according to an embodiment the present invention, details of the Bluetooth core specification, ATT operation types and messages in Table 1, and the list of features supported by the Generic Attribute profile (GATT) in Table 2 may correspond to contents disclosed in http://www.bluetooth.com.

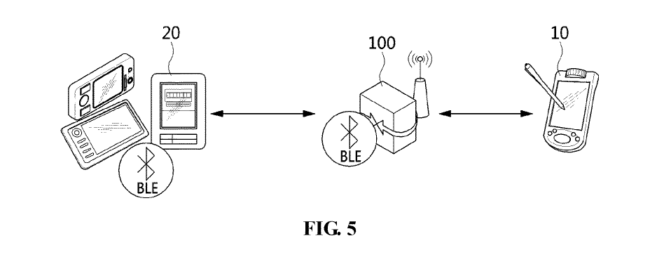

FIG. 5 is a diagram illustrating an IoT device interoperation system in which an OCF device and a non-OCF BLE device are interoperably connected to each other according to an embodiment of the present invention.

Referring to FIG. 5, in the IoT device interoperation system in which an OCF device 10 and a non-OCF BLE device 20 are interoperably connected to each other according to an embodiment of the present invention, the OCF device 10 may correspond to an OCF client, and the non-OCF BLE device 20 may correspond to a GATT server.

Further, an IoT device interoperation apparatus 100 may function as an OCF server, instead of the non-OCF BLE device 20, for the OCF device 10.

Here, the IoT device interoperation apparatus 100 may correspond to a gateway apparatus for interoperably connecting the OCF device 10 to the non-OCF BLE device 20.

That is, the IoT device interoperation apparatus 100 may include the functions of a typical gateway apparatus, and may perform gateway functions based on OCF standards.

The non-OCF BLE device 20 may correspond to any of various types of existing devices (e.g. a scale, a sphygmomanometer, etc.) that support BLE and that have been widely popularized.

As a communication protocol between the non-OCF BLE device 20 and the IoT device interoperation apparatus 100, BLE may be used.

The OCF device 10 may be a device equipped with an IoTivity stack, and may generally be, for example, a smart phone.

As a communication protocol between the OCF device 10 and the IoT device interoperation apparatus 100, any communication protocol (e.g., Ethernet, WiFi, or the like) that is supported by OCF may be used.

The following Table 3 shows an example of a characteristic database (DB) of a non-OCF BLE device according to an embodiment of the present invention.

TABLE 3

| Device type | Handle | Type (UUID) | Permission | Value |
|---|---|---|---|---|
| Heart Rate | 0x0027 | 0x1122 | READ | Bpm |
| Health | 0x0034 | 0x22ff | READ | Celsius |
| thermometer | | | | |

Referring to Table 3, the characteristic DB of the non-OCF BLE device may include a handle address, an identifier, a permitted operation, and an actual value depending on the type of device.

The communication procedure of the IoT device interoperation apparatus 100 according to an embodiment of the present invention may chiefly include an endpoint discovery procedure and a resource manipulation procedure.

When information about an OCF server is not known before communication is initiated, the OCF client may perform the endpoint discovery procedure.

Therefore, when information about the IoT device interoperation apparatus 100 is not known before communication is initiated, the OCF device 10 may perform the endpoint discovery procedure. The endpoint discovery procedure may be performed using CoAP discovery or HTTP discovery.

In accordance with an embodiment of the present invention, the IoT device interoperation apparatus 100 may perform a CoAP-based endpoint discovery procedure in order to interoperably connect the OCF device 10 to the non-OCF BLE device 20.

The CoAP-based endpoint discovery procedure may be processed in such a way as to transmit a discovery request packet to a prearranged multicast address and port and receive responses that are sent by devices joining the corresponding multicast address. Here, the devices joining the corresponding multicast address may include the IoT device interoperation apparatus 100 or other OCF devices 10.

If the OCF device 10 discovers information about the non-OCF BLE device 20 via endpoint discovery or becomes aware of the information through another path, the OCF device 10 may perform manipulation on resources mapped to the non-OCF BLE device 20 using a CRUDN operation. Here, fundamentally, all OCF nodes may join the corresponding multicast address.

Prior to all procedures described in the present invention, pairing and bonding procedures between the IoT device interoperation apparatus 100 and the non-OCF BLE device 20 may be performed in advance.

That is, the IoT device interoperation apparatus 100 according to an embodiment of the present invention may know in advance information about all non-OCF BLE devices 20 connected thereto.

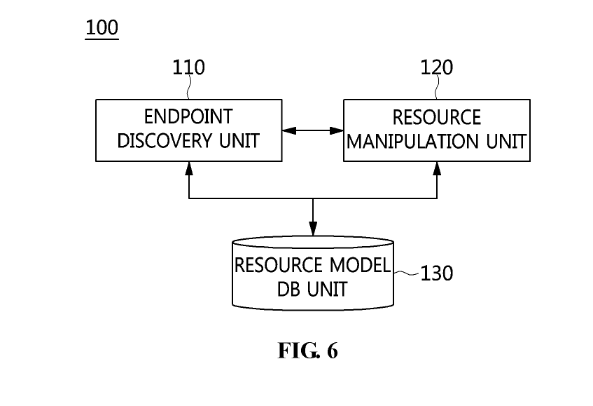

FIG. 6 is a block diagram illustrating an IoT device interoperation apparatus according to an embodiment of the present invention.

Referring to FIG. 6, the IoT device interoperation apparatus 100 according to the embodiment of the present invention may include an endpoint discovery unit 110, a resource manipulation unit 120, and a resource model DB unit 130.

The endpoint discovery unit 110 may perform an endpoint discovery procedure between the Open Connectivity Foundation (OCF) device 10 and the non-OCF BLE device 20.

The resource manipulation unit 120 may perform interoperation between the OCF device and the non-OCF BLE device by performing a resource manipulation procedure.

The resource model DB unit 130 may mange a resource model DB.

Here, the resource model DB unit 130 may write resource information to the resource model DB or update the resource information in the resource model DB in response to a request from the endpoint discovery unit 110 or the resource manipulation unit 120.

Here, the resource model DB unit 130 may read resource information requested by the endpoint discovery unit 110 and the resource manipulation unit 120 from the resource model DB, and may provide the read resource information.

Further, the resource model DB unit 130 may activate the setting of notification of resource information using the resource model DB depending on the NOTIFY operation.

In this case, the resource model DB unit 130 may deactivate the setting of notification of resource information using the resource model DB depending on the NOTIFY operation.

Here, the IoT device interoperation apparatus 100 may communicate with the OCF device 10 using a communication protocol supported by OCF and may communicate with the non-OCF BLE device 20 using Bluetooth Low Energy (BLE).

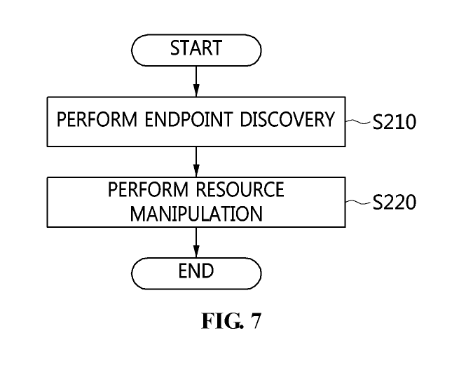

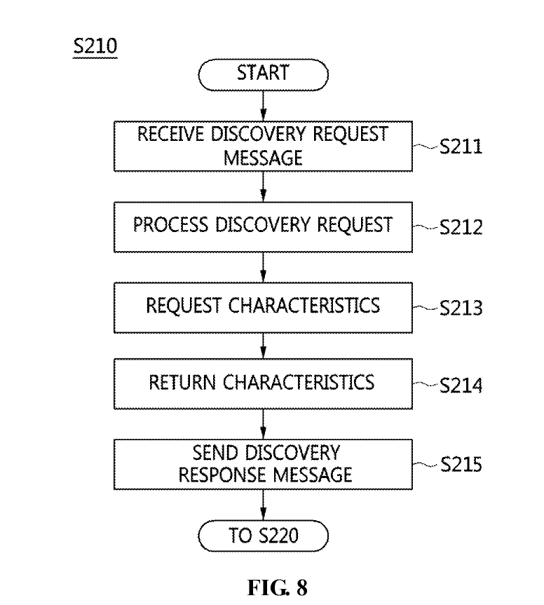

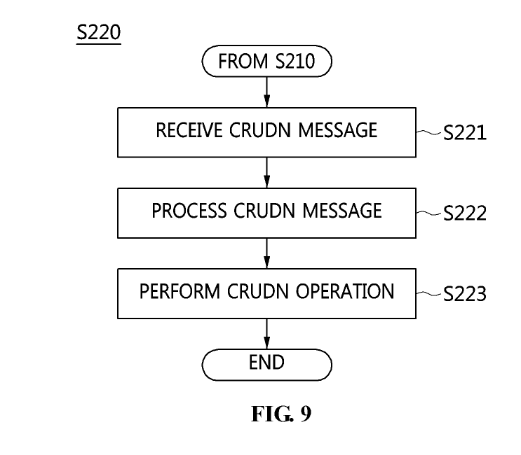

FIG. 7 is an operation flowchart illustrating an IoT device interoperation method according to an embodiment of the present invention. FIG. 8 is an operation flowchart illustrating in detail an example of the endpoint discovery step illustrated in FIG. 7. FIG. 9 is an operation flowchart illustrating in detail an example of the resource manipulation step illustrated in FIG. 7.

Referring to FIG. 7, the IoT device interoperation method according to the embodiment of the present invention may perform an endpoint discovery procedure at step S210, and may perform a resource manipulation procedure at step S220.

That is, at step S210, the endpoint discovery procedure between the OCF device 10 and the non-OCF BLE device 20 may be performed.

Referring to FIG. 8, in the procedure at step S210, a discovery request message may be received at step S211.

In detail, at step S211, when the OCF device 10 sends the discovery request message to a preset multicast address and port, a Constrained Application Protocol (CoAP)-based endpoint discovery procedure may be performed.

For example, the multicast address may correspond to an Internet Protocol version 6 (IPv6) address of FFOX::FD, and the port may correspond to 5683.

Here, at step S211, the OCF device 10 may specify a specific resource name in the discovery request message and may send the discovery request message to the IoT device interoperation apparatus 100.

Further, in the procedure at step S210, the discovery request may be processed at step S212.

That is, at step S212, resource information of all non-OCF BLE devices 20 connected to the IoT device interoperation apparatus 100 may be returned. Here, at step S212, it may be determined whether the OCF device 10 specified the specific resource name in the discovery request message. When the specific resource name is included in the discovery request message, step S212 may be configured to return a response message, with only information about the corresponding resource being included in the response message.

Further, in the procedure at step S210, characteristics may be requested at step S213.

At step S213, the IoT device interoperation apparatus 100 may check the connection states of all the non-OCF BLE devices 20 connected thereto.

Here, at step S213, the IoT device interoperation apparatus 100 may check the connection states and may reconnect to non-OCF BLE devices 20 which are disconnected therefrom.

At step S213, if connections between the IoT device interoperation apparatus 100 and non-OCF BLE devices 20 have been completed, the IoT device interoperation apparatus 100 may request services and/or characteristics from the non-OCF BLE devices 20 that have been connected using the features of “service discovery” and “characteristic discovery” that are supported by the GATT.

Examples of the GATT may correspond to details disclosed in the above Table 2.

Further, in the procedure at step S210, characteristics may be returned at step S214.

That is, at step S214, the non-OCF BLE devices 20 that have been connected may return the requested services and/or characteristics to the IoT device interoperation apparatus 100.

Here, the IoT device interoperation apparatus 100 may create resource information corresponding to the non-OCF BLE devices 20 using the received services and/or characteristics of the non-OCF BLE devices 20.

The IoT device interoperation apparatus 100 may add the created resource information to the resource model DB.

Here, the resource information may include resource names, resource URI links, etc.

The resource information may be created by referring to the results of retrieval from the file in which resource models are stored or from the Internet site on which the DB of the resource models is stored. Here, the resource information may be stored in the resource model DB so that respective pieces of resource information are associated with BLE characteristic handles corresponding to the services and/or characteristics of the non-OCF BLE devices 20.

Here, the schema information of the resource models may be provided as a separate JavaScript Object Notation (JSON) file.

Further, the Internet site on which the DB of the resource models is stored may be a oneIoTa site (www.oneiota.org) on which the DB of all resource models generated by OCF is stored.

In this case, the IoT device interoperation apparatus 100 may generate a mapping table in which OCF resource identifiers (OCF resource URIs) mapped to the pieces of resource information added to the resource model DB and BLE characteristic handles mapped to the non-OCF BLE devices 20 corresponding to the OCF resource URIs are stored.

Here, when in the mapping table, a BLE service includes one or more characteristics, an OCF resource URI may be mapped to one or more BLE characteristic handle values.

For example, it can be seen that Table 4 shows an example of an OCF resource—BLE characteristic mapping table. The example of the mapping table of Table 4 may be constructed using the characteristic DB of the non-OCF BLE device of Table 3.

TABLE 4

| Index | OCF resource URI | BLE characteristic handle |
|---|---|---|
| 0 | /Heartrate/0 | 0x0027 |
| 1 | /thermometer/0 | 0x0034 |

Referring to Table 4, ‘OCF resource URI’ may include a device name corresponding to the non-OCF BLE device 20 and an index (serial number) for identifying the same type of device.

As shown in Table 4, the OCF resource identifier (URI) may be generated in the format of /<device name>/<n>.

However, the format of the OCF resource URI is not limited thereto, and the OCF resource URI may be generated in other formats, as long as the OCF resource URI contains required information.

Here, ‘n’ may be an index (serial number) added to provide for the case where one or more devices of the same type are connected (where n=0, 1, 2, . . . ).

‘BLE characteristic handle’ may correspond to the handle value of a characteristic included in the service of the non-OCF BLE device 20.

For example, as shown in Table 4, in index ‘0’, the ‘heartrate’ of the OCF resource URI may be the name of an OCF device corresponding to a non-OCF BLE heart rate device, and ‘0’ means that the device is a first device. ‘BLE characteristic handle 0x0027’ denotes the characteristic handle value of the non-OCF BLE device mapped to the OCF resource URI.

Further, in the procedure at step S210, a discovery response message may be sent at step S215.

That is, the IoT device interoperation apparatus 100 may update the DB by creating resource information using the characteristics received at step S214, and may generate a response message corresponding to the discovery request at step S212 using the updated DB and send the response message to the OCF device 10.

Here, at step S215, the discovery response message may be returned to the OCF device 10, with all or part of the resource information being included in the discovery response message.

Here, at step S215, all or part of the resource information may be included in the discovery response message, based on the results of determining whether the OCF device 10 specified the specific resource name in the discovery request message at step S212.

Here, at step S215, if it is determined that a specific resource name is specified, only resource information corresponding to the specific resource name may be included in the discovery response message.

In contrast, at step S215, if it determined that a specific resource name is not specified, all or part of the resource information of all non-OCF BLE devices 20 that have been connected at step S213 may be included in the discovery response message.

Further, step S210 may further include, before receiving the discovery request message at step S211, the step of receiving and processing characteristics.

That is, the step of receiving and processing the characteristics may be configured such that, when connection between the IoT device interoperation apparatus 100 and the non-OCF BLE device 20 is made, the IoT device interoperation apparatus 100 may receive services and/or characteristics from the non-OCF BLE devices 20.

The step of receiving and processing the characteristics may be performed by connecting each non-OCF BLE device 20 to the IoT device interoperation apparatus 100 through pairing when the power of the non-OCF BLE device 20 has been turned on.

Here, the step of receiving and processing the characteristics may be configured such that the IoT device interoperation apparatus 100 adds resource information corresponding to the services and/or characteristics, received at step S214, to the resource model DB.

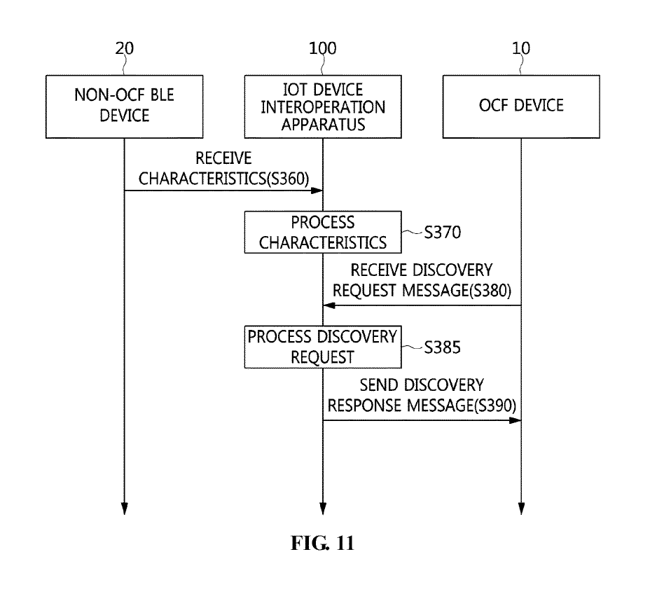

An example of the step of receiving and processing characteristics will be described in detail below with reference to the sequence diagram of FIG. 11.

Further, the IoT device interoperation method according to the embodiment of the present invention may perform a resource manipulation procedure at step S220.

That is, at step S220, the resource manipulation procedure may be performed using a CRUDN (CREATE, RETRIEVE, UPDATE, DELETE and NOTIFY) operation, and then interoperation between the OCF device 10 and the non-OCF BLE device 20 may be performed.

Referring to FIG. 9, in the procedure at step S220, a CRUDN message may be first received at step S221.

That is, at step S221, the IoT device interoperation apparatus 100 may receive a CRUDN message for performing respective operations which satisfy RESTful-style CRUDN operation (CREATE, RETRIEVE, UPDATE, DELETE and NOTIFY) from the OCF device 10.

Further, in the procedure at step S220, the CRUDN message may be processed at step S222.

That is, at step S222, the IoT device interoperation apparatus 100 may process the received CRUDN message and may check parameters and information contained in the CRUDN message.

The following Table 5 shows examples of parameters contained in the CRUDN message.

TABLE 5

| | | Full | |
|---|---|---|---|
| Application | Parameter | parameter | |
| target | name | name | Parameter definition |
| All messages | Fr | From | URI of a message sender |
| | To | To | URI of a message recipient |
| | Ri | Request | Id that enables a message |
| | | identifier | sender and a message recipient |
| | | | to identify message |
| | Cn | Content | Information related to message |
| | | | operation |
| Request | Op | Operation | Specify an operation to be |
| | | | performed by server |
| | Obs | Observe | Indicates that the current |
| | | | message is an Observe request |
| Response | Rs | Response | Indicates result values of |
| | | code | operation performed by the |
| | | | server |
| | Obs | Observe | Indicates that the current |
| | | | message is an Observe |
| | | | response |

Further, in the procedure at step S220, the CRUDN operation may be performed at step S223.

That is, at step S223, respective operations satisfying the CRUDN operation (CREATE, RETRIEVE, UPDATE, DELETE, and NOTIFY) may be performed based on the parameters and information contained in the CRUDN message.

Here, at step S223, the IoT device interoperation apparatus 100 may interoperably connect the OCF device 10 to the non-OCF BLE device based on the CRUDN operation.

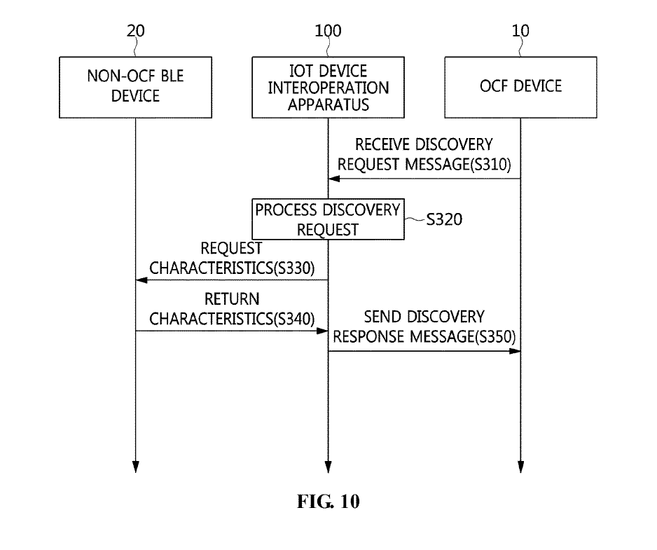

Hereinafter, the CRUDN operation, which is a detailed process for interoperably connecting IoT devices to each other via the endpoint discovery procedure at step S210 and the resource manipulation procedure at step S220, will be described in detail using respective sequence diagrams with reference to FIGS. 10 to 18.

Further, the resource manipulation unit 120 of the IoT device interoperation apparatus 100 according to an embodiment of the present invention may perform the above-described step S220 and detailed steps 5221 to S223.

A detailed process of the endpoint discovery method at the above-described step S210 according to an embodiment of the present invention will be described in detail with reference to the sequence diagram of FIG. 10.

FIG. 10 is a sequence diagram illustrating an endpoint discovery method according to an embodiment of the present invention.

Referring to FIG. 10, in the endpoint discovery method according to the embodiment of the present invention, the IoT device interoperation apparatus 100 may receive a discovery request message from the OCF device 10 at step S310.

In detail, at step S310, when the OCF device 10 sends the discovery request message to a preset multicast address and port, a Constrained Application Protocol (CoAP)-based endpoint discovery procedure may be performed.

For example, the multicast address may correspond to an Internet Protocol version 6 (IPv6) address of FFOX::FD, and the port may correspond to 5683.

Here, at step S310, the OCF device 10 may specify a specific resource name in the discovery request message and may send the discovery request message to the IoT device interoperation apparatus 100.

Further, the endpoint discovery method according to an embodiment of the present invention may process the discovery request at step S320.

Here, at step S320, it may be determined whether the OCF device 10 specified a specific resource name in the discovery request message.

Next, in the endpoint discovery method according to an embodiment of the present invention, the IoT device interoperation apparatus 100 may request characteristics from the non-OCF BLE devices 20 at step S330.

Here, at step S330, the IoT device interoperation apparatus 100 may check the connection states of all non-OCF BLE devices 20 connected thereto, and may reconnect to non-OCF BLE devices 20 that have been disconnected from the IoT device interoperation apparatus 100.

At step S330, if connections between the IoT device interoperation apparatus 100 and non-OCF BLE devices 20 have been completed, the IoT device interoperation apparatus 100 may request services and/or characteristics from the non-OCF BLE devices 20 that have been connected using the features of “service discovery” and “characteristic discovery” that are supported by the GATT.

Next, the endpoint discovery method according to the embodiment of the present invention may return the characteristics at step S340.

That is, at step S340, the non-OCF BLE devices 20 may return the requested services and/or characteristics to the IoT device interoperation apparatus 100.

Here, the IoT device interoperation apparatus 100 may add OCF resource information, corresponding to the non-OCF BLE devices 20, to the resource model DB using the received services and/or characteristics of the non-OCF BLE devices 20.

Here, the resource information may be created by referring to the results of retrieval from the file in which resource models are stored or from the Internet site on which the DB of the resource models is stored. Here, the resource information may be stored in the resource model DB so that respective pieces of resource information are associated with BLE characteristic handles corresponding to the services and/or characteristics of the non-OCF BLE devices 20.

Here, the IoT device interoperation apparatus 100 may add the created OCF resource information to the resource model DB.

Here, the resource information may include resource names, resource URI links, etc.

Here, the schema information of the resource models may be provided as a separate JavaScript Object Notation (JSON) file.

Further, the Internet site on which the DB of the resource models is stored may be a oneIoTa site (www.oneiota.org) on which the DB of all resource models generated by OCF is stored.

In this case, the IoT device interoperation apparatus 100 may generate a mapping table in which OCF resource identifiers (OCF resource URIs) mapped to the pieces of resource information added to the resource model DB and BLE characteristic handles mapped to the non-OCF BLE devices 20 corresponding to the OCF resource URIs are stored.

The OCF resource URIs or BLE characteristic handles have been described above with reference to Table 4.

Next, the endpoint discovery method according to the embodiment of the present invention may send a discovery response message at step S350.

That is, at step S350, the IoT device interoperation apparatus 100 may send a response message to the OCF device 10 in response to the discovery request from the OCF device 10.

At step S350, the discovery response message may be returned to the OCF device 10, with all or part of the resource information being included in the discovery response message.

Here, at step S350, all or part of the resource information may be included in the discovery response message, based on the results of determining whether the OCF device 10 specified the specific resource name in the discovery request message.

Here, at step S350, if it is determined that the specific resource name is specified, only resource information corresponding to the specific resource name may be included in the discovery response message.

In contrast, at step S350, if it determined that a specific resource name is not specified, all or part of the resource information of all non-OCF BLE devices 20 that have been connected at step S330 may be included in the discovery response message.

FIG. 11 is a sequence diagram illustrating another embodiment of the endpoint discovery method illustrated in FIG. 10.

Referring to FIG. 11, the endpoint discovery method according to the embodiment of the present invention may receive characteristics at step S360.

That is, at step S360, the IoT device interoperation apparatus 100 may receive characteristics from non-OCF BLE devices 20 using the features of the GATT.

Here, step S360 may be performed on condition that the IoT device interoperation apparatus 100 is connected to each non-OCF BLE device 20.

Step S360 may be configured such that, after connections between the IoT device interoperation apparatus 100 and the non-OCF BLE devices 20 have been completed, the IoT device interoperation apparatus 100 may receive services and/or characteristics from the non-OCF BLE devices 20.

Then, the endpoint discovery method according to the embodiment of the present invention may process the characteristics at step S370.

That is, at step S370, the IoT device interoperation apparatus 100 may add OCF resource information, corresponding to the non-OCF BLE devices 20, to the resource model DB of the IoT device interoperation apparatus 100 using the received services and/or characteristics of the non-OCF BLE devices 20.

Here, at step S370, the OCF resource information corresponding to the services and/or characteristics of the non-OCF BLE devices 20 may be created by referring to the results of retrieval from the file in which resource models are stored or from the Internet site on which the DB of the resource models is stored.

Further, at step S370, the resource information created by the IoT device interoperation apparatus 100 may be added to the resource model DB of the IoT device interoperation apparatus 100.

Here, step S370 may be configured to store OCF resource information in which OCF resource URIs and BLE characteristic handles corresponding to non-OCF BLE devices match each other in the resource model DB.

Referring to Table 4, ‘OCF resource URI’ may include a device name corresponding to each non-OCF BLE device 20 and an index (serial number) for identifying the same type of device.

‘BLE characteristic handle’ may correspond to the handle value of the characteristic of the non-OCF BLE device 20.

Furthermore, in the endpoint discovery method according to the embodiment of the present invention, the IoT device interoperation apparatus 100 may receive a discovery request message from the OCF device 10 at step S380.

Next, the endpoint discovery method according to the embodiment of the present invention may process the discovery request and generate a discovery response message at step S385, and may send the discovery response message at step S390.

At step S390, the discovery response message may be returned to the OCF device 10, with all or part of the resource information being included in the discovery response message.

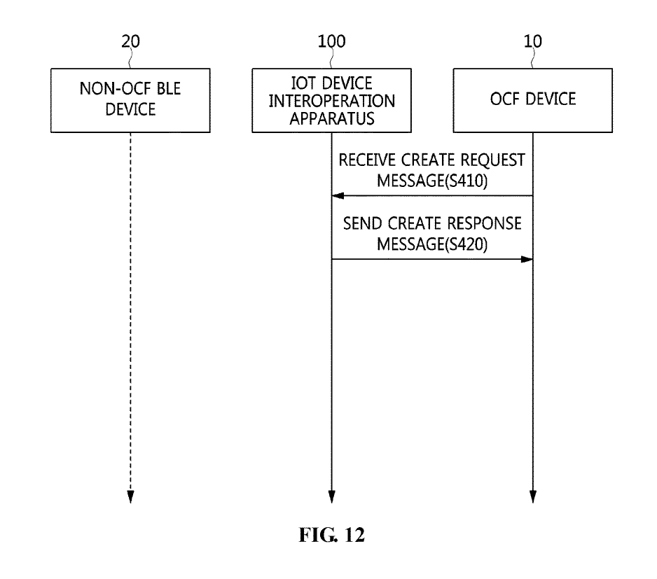

Further, a detailed process of the CRUDN operation according to the embodiment of the present invention, described above at step S220, will be described in detail later with reference to sequence diagrams in FIGS. 12 to 18.

A description of attributes and features used by the GATT profile according to the embodiment of the present invention has been made above with reference to Table 2.

Here, the detailed description of individual parameters for a CRUDN message according to an embodiment of the present invention has been made above with reference to Table 5.

FIG. 12 is a sequence diagram showing a CREATE operation performance method according to an embodiment of the present invention.

Referring to FIG. 12, the CREATE operation performance method according to the embodiment of the present invention may receive a CREATE request message at step S410.

That is, at step S410, the OCF device 10 may request the IoT device interoperation apparatus 100 to create a new resource.

Here, the OCF device 10 may generate a CREATE request message that includes information about the resource to be newly created using a content parameter Cn in order to request the creation of the new resource.

At step S410, the OCF device 10 may send a CREATE request message to the IoT device interoperation apparatus 100.

Here, at step S410, the IoT device interoperation apparatus 100 may receive the CREATE request message.

However, since the non-OCF BLE device 20 does not support the feature of creating new characteristics, it cannot create new characteristics.

Therefore, the IoT device interoperation apparatus 100 cannot create new resource information for the non-OCF BLE device 20, either.

Further, in the CREATE operation performance method according to the embodiment of the present invention, the IoT device interoperation apparatus 100 may send a CREATE response message to the OCF device 10 at step S420.

In detail, at step S420, the IoT device interoperation apparatus 100 may respond to the OCF device 10 to indicate that new resource information cannot be created.

At step S420, the IoT device interoperation apparatus 100 may generate a CREATE response message containing a response code 4.05 (Method Not Allowed) as a response code parameter Rs in order to indicate that a new resource information create request cannot be processed.

At step S420, the OCF device 10 may identify that new resource information cannot be created by checking the response code 4.05 (Method Not Allowed) through the response code parameter Rs contained in the received CREATE response message.

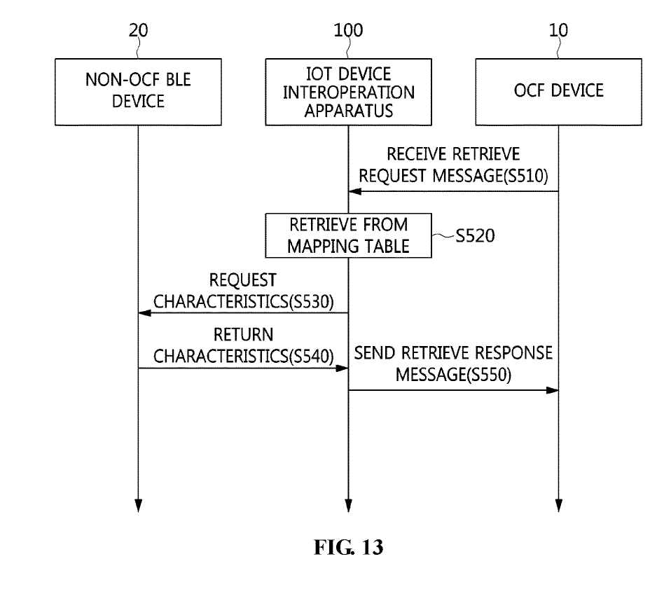

FIG. 13 is a sequence diagram showing a RETRIEVE operation performance method according to an embodiment of the present invention.

Referring to FIG. 13, the RETRIEVE operation performance method according to the embodiment of the present invention may receive a RETRIEVE request message at step S510.

That is, at step S510, the OCF device 10 may request resource information in a current state from the IoT device interoperation apparatus 100.

At step S510, the OCF device 10 may generate a RETRIEVE request message in which the URI of the resource requested by the OCF device 10 is included in a To parameter in order to make a RETRIEVE request.

Next, the RETRIEVE operation performance method according to the embodiment of the present invention may retrieve information from a mapping table at step S520.

That is, at step S520, an OCF resource URI and a BLE characteristic handle value, which correspond to the URI stored in the To parameter, may be retrieved from the mapping table such as that shown in the example of Table 4.

Next, the RETRIEVE operation performance method according to the embodiment of the present invention may request the reading of a characteristic value at step S530.

That is, at step S530, the IoT device interoperation apparatus 100 may request a characteristic value from the non-OCF BLE device 20.

Here, step S530 may be configured such that the IoT device interoperation apparatus 100 requests a characteristic value corresponding to a BLE characteristic handle value using the feature of “Characteristic Value Read” supported by the GATT.

Further, the RETRIEVE operation performance method according to the embodiment of the present invention may return the characteristic value at step S540.

In detail, at step S540, the non-OCF BLE device 20 may return the requested characteristic value to the IoT device interoperation apparatus 100.

Next, the RETRIEVE operation performance method according to the embodiment of the present invention may send a RETRIEVE response message at step S550.

In detail, at step S550, resource information in the current state may be created using the received characteristic value.

That is, at step S550, the IoT device interoperation apparatus 100 may send a RETRIEVE response message to the OCF device 10 such that all or part of the resource information corresponding to the received characteristic value is included in the RETRIEVE response message.

Here, the IoT device interoperation apparatus 100 may update the received characteristic value in the entry value of the resource model DB corresponding to the received characteristic value.

Here, the RETRIEVE response message may include the URI of the resource included in the RETRIEVE request message.

In this case, the IoT device interoperation apparatus 100 may send a RETRIEVE response message including the resource information (containing the URI of the resource included in the RETRIEVE request message) requested by the OCF device 10 to the OCF device 10 using a content parameter Cn.

Here, at step S550, the OCF device 10 may determine the requested resource information in the current state by checking the received RETRIEVE response message.

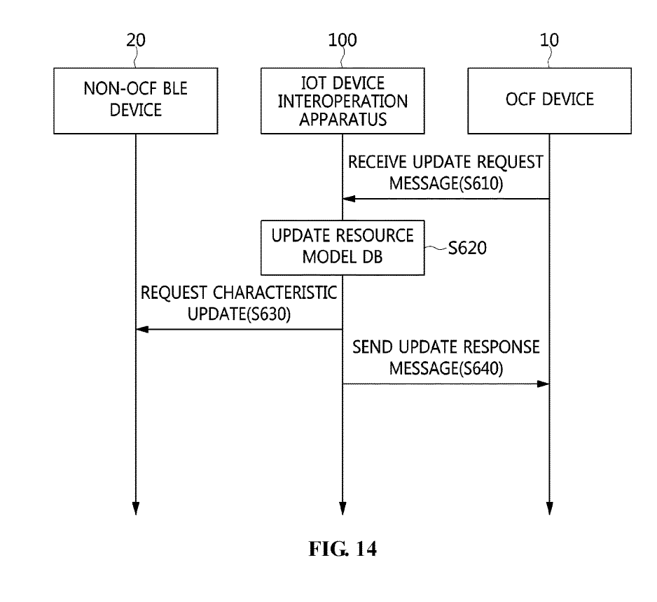

FIG. 14 is a sequence diagram showing an UPDATE operation performance method according to an embodiment of the present invention.

Referring to FIG. 14, the UPDATE operation performance method according to the embodiment of the present invention may receive an UPDATE request message at step S610.

That is, at step S610, the OCF device 10 may request the IoT device interoperation apparatus 100 to update resource information.

At step S610, in order to request the update of a specific resource, the OCF device 10 may generate an UPDATE request message in which the URI of a target resource requested to be updated is included in a To parameter and in which the update information of the resource is included in a content parameter Cn.

Then, the UPDATE operation performance method according to the embodiment of the present invention may update a resource model DB at step S620.

That is, at step S620, the update information of the resource included in the UPDATE request message may be updated in the resource model DB.

In detail, at step S620, the IoT device interoperation apparatus 100 may retrieve an OCF resource identifier (OCF resource URI) and a BLE characteristic handle value, which correspond to the resource that is requested to be updated and that is included in the UPDATE request message, from a mapping table.

Next, the UPDATE operation performance method according to the embodiment of the present invention may request the writing of a characteristic value at step S630.

That is, at step S630, the IoT device interoperation apparatus 100 may request the non-OCF BLE device 20 to update the characteristic value.

Here, at step S630, the IoT device interoperation apparatus 100 may request the update of the characteristic value corresponding to a BLE characteristic handle value using the feature of “Characteristic Value Write” supported by the GATT.

In detail, at step S630, the IoT device interoperation apparatus 100 may request the non-OCF BLE device 20 to update the retrieved characteristic value.

Here, at step S630, the non-OCF BLE device 20 may update the characteristic value requested to be updated.

Then, the UPDATE operation performance method according to the embodiment of the present invention may send an UPDATE response message at step S640.

That is, at step S640, the IoT device interoperation apparatus 100 may send an UPDATE response message including the results of update to the OCF device 10.

At step S640, the OCF device 10 may determine whether the requested resource information has been updated by checking the UPDATE response message.

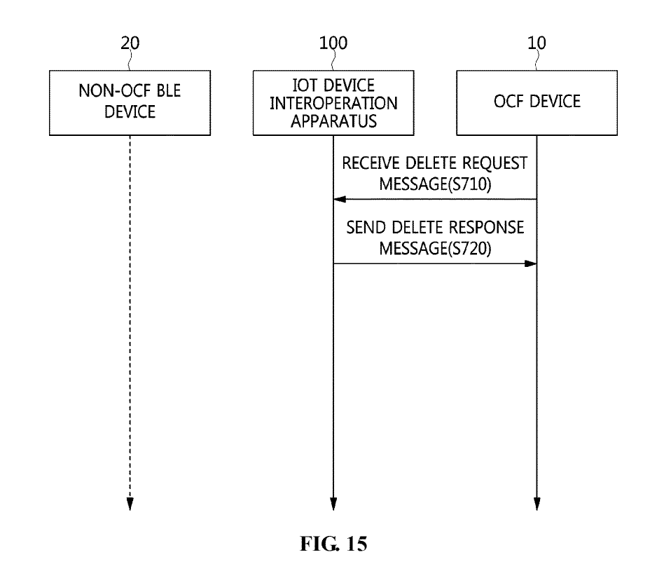

FIG. 15 is a sequence diagram showing a DELETE operation performance method according to an embodiment of the present invention.

Referring to FIG. 15, the DELETE operation performance method according to the embodiment of the present invention may receive a DELETE request message at step S710.

That is, at step S710, the OCF device 10 may request the IoT device interoperation apparatus 100 to delete an existing resource.

At step S710, the OCF device 10 may generate a DELETE request message in which the URI of the existing resource to be deleted is included in a To parameter in order to make a DELETE request.

Here, at step S710, the OCF device 10 may send the DELETE request message to the IoT device interoperation apparatus 100.

However, since the non-OCF BLE device does not support the feature of deleting existing characteristics, it cannot delete the existing characteristics.

Therefore, the IoT device interoperation apparatus 100 cannot delete the existing resource information in relation to the non-OCF BLE device, either.

Further, in the DELETE operation performance method according to the embodiment of the present invention, the IoT device interoperation apparatus 100 may send a DELETE response message to the OCF device 10 at step S720.

That is, at step S720, the IoT device interoperation apparatus 100 may respond to the OCF device 10 to indicate that the existing resource information cannot be deleted.

Here, at step S720, in order to send a response indicating that the deletion of the existing resource information that was requested to be deleted cannot be processed, the IoT device interoperation apparatus 100 may generate a DELETE response message in which a response code 4.05 (Method Not Allowed) is included in a response code parameter Rs.

At step S720, the IoT device interoperation apparatus 100 may send the DELETE response message to the OCF device 10.

Further, at step S720, the OCF device 10 may determine that the existing resource information cannot be deleted by checking the response code 4.05 (Method Not Allowed) of the response code parameter Rs included in the received DELETE response message.

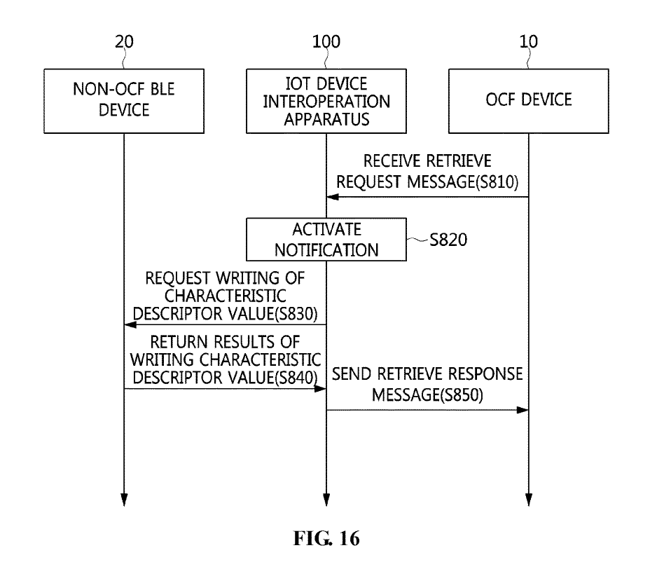

FIG. 16 is a sequence diagram showing a NOTIFY operation performance method for activating notification setting according to an embodiment of the present invention.

Referring to FIG. 16, the NOTIFY operation performance method for activating notification setting according to the embodiment of the present invention may first receive a RETRIEVE request message at step S810.

The NOTIFY operation is used to notify an OCF client of the change of resource information in an OCF server using an asynchronous method. This operation is composed of two operations, that is, observe setting that is executed by the OCF client on the OCF server and notification that allows the OCF server to notify the OCF client of the change of a resource whenever the resource is changed.

That is, at step S810, the IoT device interoperation apparatus 100 may receive a RETRIEVE request message from the OCF device 10.

Here, at step S810, in order to receive notification of the corresponding change whenever a specific resource is changed, the OCF device 10 may generate a RETRIEVE request message in which the URI of a resource, for which notification is to be requested, is included in a To parameter and in which information indicating activation of notification setting is included in an Observe parameter Obs.

At step S810, the OCF device 10 may send the RETRIEVE request message to the IoT device interoperation apparatus 100.

At step S810, the IoT device interoperation apparatus 100 may receive the RETRIEVE request message.

Next, the NOTIFY operation performance method for activating notification setting according to the embodiment of the present invention may activate notification setting at step S820.

That is, at step S820, an OCF resource URI and a BLE characteristic handle value, which correspond to the URI of the To parameter, may be retrieved from the mapping table according to an example, such as that shown in Table 4.

Here, at step S820, notification setting of the characteristic corresponding to the resource information of the resource model DB mapped to the retrieved BLE characteristic handle value may be activated.

Further, the NOTIFY operation performance method for activating notification setting according to the embodiment of the present invention may request the writing of a characteristic descriptor value (i.e. “Characteristic Descriptor Value Write”) at step S830.

That is, at step S830, the IoT device interoperation apparatus 100 may request the non-OCF BLE device 20 to write a characteristic description value.

Here, at step S830, the IoT device interoperation apparatus 100 may enable a notification bit included in a Client Characteristic Configuration Descriptor (CCCD) for the characteristic of the non-OCF BLE device 20 that corresponds to the BLE characteristic handle value using the feature of “Characteristic Descriptor Value Write” supported by the GATT.

Further, the NOTIFY operation performance method for activating notification setting according to the embodiment of the present invention may return the results of requesting the writing of the characteristic descriptor value at step S840.

That is, at step S840, the non-OCF BLE device 20 may return the results of enabling the notification bit to the IoT device interoperation apparatus 100.

Next, the NOTIFY operation performance method for activating notification setting according to the embodiment of the present invention may send a RETRIEVE response message at step S850.

That is, at step S850, the IoT device interoperation apparatus 100 may send the RETRIEVE response message to the OCF device 10.

Here, step S850 may be performed based on the results of requesting the writing of the characteristic descriptor value received by the IoT device interoperation apparatus 100.

At step S850, the IoT device interoperation apparatus 100 may generate a RETRIEVE response message that includes the results of completing the activation of notification setting to respond to the RETRIEVE request message.

At step S850, the IoT device interoperation apparatus 100 may generate a RETRIEVE response message in which the results of completing the activation of notification setting, rather than the change of resource information, are included in the Observe parameter Obs.

Here, at step S850, the IoT device interoperation apparatus 100 may send the RETRIEVE response message, including the results of completing the activation of notification setting, to the OCF device 10.

At step S850, the OCF device 10 may determine whether the activation of notification setting of requested resource information has been completed, by checking the received RETRIEVE response message.

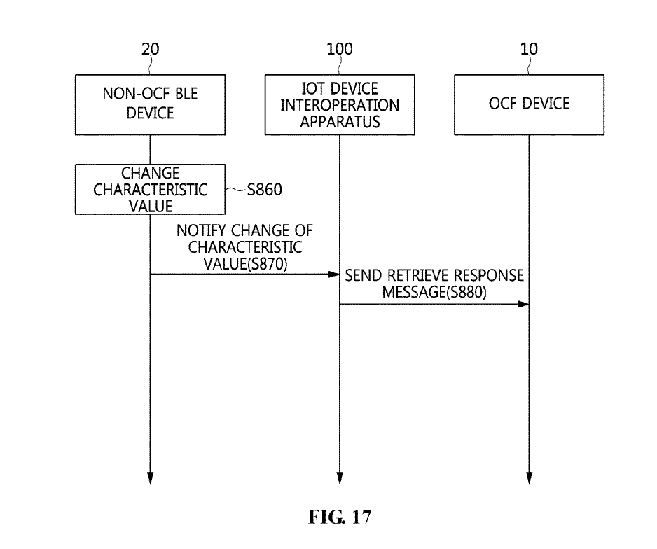

FIG. 17 is a sequence diagram showing a NOTIFY operation performance method depending on the change of a characteristic value according to an embodiment of the present invention.

The NOTIFY operation performance method depending on the change of a characteristic value, shown in FIG. 17, may be performed subsequent to step S850 corresponding to the NOTIFY operation performance method for activating notification setting, shown in FIG. 16.

Here, the NOTIFY operation performance method depending on the change of a characteristic value may be performed when the change of a characteristic value in which a notification bit is enabled in advance in the characteristic of the non-OCF BLE device 20 is observed, even if there is no resource information request from the OCF device 10.

Referring to FIG. 17, the NOTIFY operation performance method depending on the change of a characteristic value according to an embodiment of the present invention may observe the change of a characteristic value at step S860.

That is, at step S860, the non-OCF BLE device 20 may observe the change of the characteristic value.

Next, the NOTIFY operation performance method depending on the change of a characteristic value according to the embodiment of the present invention may provide notification of the change of the characteristic value at step S870.

That is, at step S870, the non-OCF BLE device 20 may notify the IoT device interoperation apparatus 100 of the changed characteristic value.

Here, at step S870, when the characteristic in which the notification bit is enabled in advance is changed, the non-OCF BLE device 20 may notify the IoT device interoperation apparatus 100 of the changed characteristic value using the feature of “Characteristic Value Notification” supported by the GATT.

Further, the NOTIFY operation performance method depending on the change of a characteristic value according to the embodiment of the present invention may send a RETRIEVE response message at step S880.

That is, at step S880, the IoT device interoperation apparatus 100 may send the RETRIEVE response message to the OCF device 10.

Here, at step S880, the IoT device interoperation apparatus 100 may update changed resource information corresponding to the changed characteristic value in the resource model DB.

At step S880, the IoT device interoperation apparatus 100 may update the resource model DB using a mapping table.

At step S880, the IoT device interoperation apparatus 100 may check the update of the resource model DB and may then determine whether the notification setting of the updated resource information has been activated.

Here, at step S880, if it is determined that the notification setting of the updated resource information has been activated, the IoT device interoperation apparatus 100 may generate a RETRIEVE response message.

At step S880, the IoT device interoperation apparatus 100 may generate a RETRIEVE response message in which the updated resource information is included in a content parameter Cn.

Here, at step S880, the IoT device interoperation apparatus 100 may send the RETRIEVE response message to the OCF device 10.

At step S880, the OCF device 10 may determine whether the characteristic value of the non-OCF BLE device 20 has been changed by checking the updated resource information of the received RETRIEVE response message.

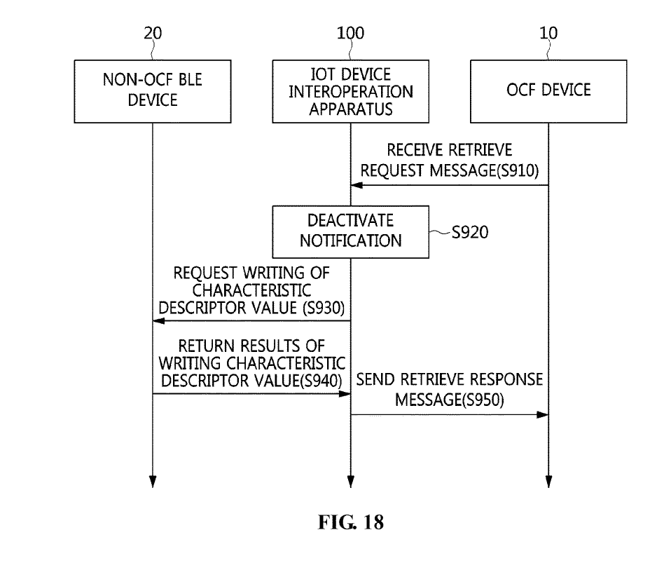

FIG. 18 is a sequence diagram showing a NOTIFY operation performance method for deactivating notification setting according to an embodiment of the present invention.

Referring to FIG. 18, the NOTIFY operation performance method for deactivating notification setting according to the embodiment of the present invention may receive a RETRIEVE request message at step S910.

That is, at step S910, the IoT device interoperation apparatus 100 may receive the RETRIEVE request message from the OCF device 10.

Here, at step S910, in order to deactivate notification of a specific resource, the OCF device 10 may generate a RETRIEVE request message in which the URI of a resource, for which the deactivation of NOTIFICATION setting is to be requested, is included in a To parameter and in which information indicating the deactivation of notification setting is included in an Observe parameter Obs.

At step S910, the OCF device 10 may send the RETRIEVE request message to the IoT device interoperation apparatus 100.

Further, the NOTIFY operation performance method for deactivating notification setting according to the embodiment of the present invention may deactivate notification setting at step S920.

That is, at step S920, an OCF resource URI and a BLE characteristic handle value, which correspond to the To parameter, may be retrieved from the mapping table according to an embodiment such as that shown in Table 4.

Here, at step S920, notification setting of resource information in the resource model DB corresponding to the retrieved BLE characteristic handle value may be deactivated.

Then, the NOTIFY operation performance method for deactivating notification setting according to the embodiment of the present invention may request the writing of a characteristic descriptor value (i.e. “Characteristic Descriptor Value Write”) at step S930.

That is, at step S930, the IoT device interoperation apparatus 100 may request the non-OCF BLE device 20 to write a Characteristic Descriptor value.

At step S930, the IoT device interoperation apparatus 100 may disable a notification bit included in the Client Characteristic Configuration Descriptor (CCCD) of the characteristic of the non-OCF BLE device 20, corresponding to the BLE characteristic handle value, using the feature of “Characteristic Descriptor Value Write” supported by the GATT.

Further, the NOTIFY operation performance method for deactivating notification setting according to the embodiment of the present invention may return the results of writing the characteristic descriptor value at step S940.

That is, at step S940, the non-OCF BLE device 20 may return the results of disabling the notification bit to the IoT device interoperation apparatus 100.

Next, the NOTIFY operation performance method for deactivating notification setting according to the embodiment of the present invention may send a RETRIEVE response message at step S950.

That is, at step S950, the IoT device interoperation apparatus 100 may send the RETRIEVE response message to the OCF device 10.

Here, at step S950, the IoT device interoperation apparatus 100 may determine the received results of requesting the writing of the characteristic descriptor value.

At step S950, the IoT device interoperation apparatus 100 may generate a RETRIEVE response message, including the results of completing the deactivation of notification setting, to respond to the RETRIEVE request message.

Here, at step S950, the IoT device interoperation apparatus 100 may generate a RETRIEVE response message, in which the results of completing the deactivation of notification setting, rather than the change of resource information, are included in the Observe parameter Obs.

At step S950, the IoT device interoperation apparatus 100 may send the RETRIEVE response message including the results of completing the deactivation of notification setting to the OCF device 10.

Here, at step S950, the OCF device 10 may determine whether the deactivation of notification setting of the requested resource information has been completed by checking the received RETRIEVE response message.

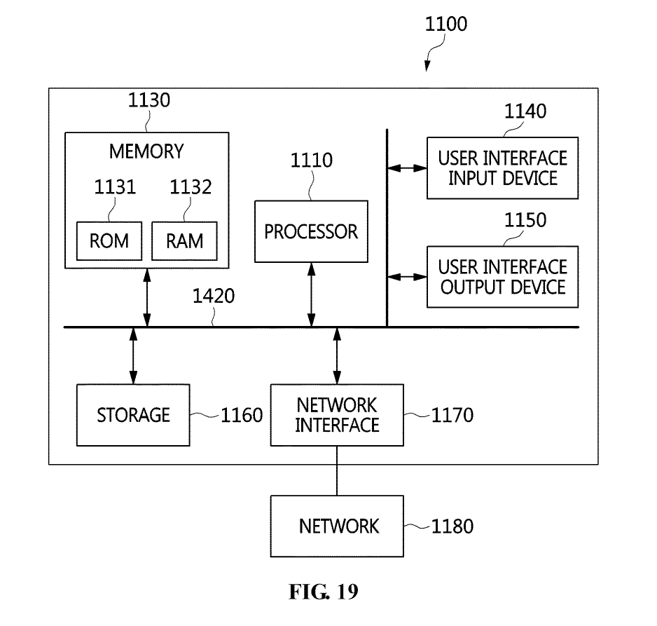

FIG. 19 is a block diagram illustrating a computer system according to an embodiment of the present invention.

Referring to FIG. 19, the embodiment of the present invention may be implemented in a computer system 1100 such as a computer-readable storage medium. As shown in FIG. 19, the computer system 1100 may include one or more processors 1110, memory 1130, a user interface input device 1140, a user interface output device 1150, and storage 1160, which communicate with each other through a bus 1120. The computer system 1100 may further include a network interface 1170 connected to a network 1180. Each of the processors 1110 may be a Central Processing Unit (CPU) or a semiconductor device for executing processing instructions stored in the memory 1130 or the storage 1160. Each of the memory 1130 and the storage 1160 may be any of various types of volatile or nonvolatile storage media. For example, the memory 1130 may include Read Only Memory (ROM) 1131 or Random Access Memory (RAM).

The present invention may interoperably connect an OCF device that supports an OCF framework to an existing non-OCF BLE device that does not support the OCF framework.

Further, the present invention may allow a gateway for interoperation between an OCF device and a non-OCF BLE device to communicate with the non-OCF BLE device using the feature of a Generic ATTribute profile (GATT) when receiving a Representational State Transfer (REST) architectural style (i.e. RESTful) operation from the OCF device and to provide the results of communication with the non-OCF BLE device to the OCF device through a RESTful style operation.

As described above, in the IoT device interoperation apparatus and method according to the present invention, the configurations and schemes in the above-described embodiments are not limitedly applied, and some or all of the above embodiments can be selectively combined and configured so that various modifications are possible.

What is claimed is:

1. An Internet-of-Things (IoT) device interoperation method using an IoT device interoperation apparatus, comprising:
performing an endpoint discovery procedure between an Open Connectivity Foundation (OCF) device and a non-OCF Bluetooth Low Energy (BLE) device; and
performing interoperation between the OCF device and the non-OCF BLE device by performing a resource manipulation procedure using a Create, Retrieve, Update, Delete, and Notify (CRUDN) operation.

2. The IoT device interoperation method of claim 1, wherein the IoT device interoperation apparatus communicates with the OCF device using a communication protocol supported by OCF, and communicates with the non-OCF BLE device using BLE.

3. The IoT device interoperation method of claim 2, wherein performing the endpoint discovery procedure is configured such that the IoT device interoperation apparatus and the OCF device exchange discovery messages with each other using a Constrained Application Protocol (CoAP)-based endpoint discovery procedure.

4. The IoT device interoperation method of claim 2, wherein performing the endpoint discovery procedure is configured such that the IoT device interoperation apparatus requests a characteristic from the non-OCF BLE device using a Generic Attribute profile (GATT).

5. The IoT device interoperation method of claim 4, wherein performing the endpoint discovery procedure is performed using an OCF resource-BLE characteristic mapping table in which OCF resources are mapped to BLE characteristics.

6. The IoT device interoperation method of claim 5, wherein the OCF resource-BLE characteristic mapping table is a table in which OCF resource identifiers (OCF resource URIs) corresponding to the OCF resources are mapped to BLE characteristic handles corresponding to the BLE characteristics.

7. The IoT device interoperation method of claim 6, wherein each of the OCF resource URIs comprises a device name and an index for identifying an identical type of device.

8. The IoT device interoperation method of claim 7, wherein performing the endpoint discovery procedure is configured to allow the IoT device interoperation apparatus to send a discovery response message to the OCF device such that all or part of resource information corresponding to a resource name specified in a discovery request message received from the OCF device is included in the discovery response message.

9. The IoT device interoperation method of claim 8, wherein performing the interoperation is configured such that the IoT device interoperation apparatus performs the CRUDN operation based on a parameter included in a CRUDN request message received from the OCF device.

10. The IoT device interoperation method of claim 9, wherein performing the interoperation is configured such that the IoT device interoperation apparatus retrieves an OCF resource URI and a BLE characteristic handle value, which correspond to the parameter included in the CRUDN request message received from the OCF device, from the OCF resource-BLE characteristic mapping table.

11. The IoT device interoperation method of claim 10, wherein performing the interoperation is configured to:
when the IoT device interoperation apparatus performs an update operation, update resource information to be updated, included in an update request message received from the OCF device, in a resource model database (DB), and
retrieve an OCF resource URI and a BLE characteristic handle value, which correspond to a URI of the resource information to be updated, from the OCF resource-BLE characteristic mapping table.

12. The IoT device interoperation method of claim 11, wherein performing the interoperation is configured such that the IoT device interoperation apparatus requests a characteristic value corresponding to the BLE characteristic handle value from the non-OCF BLE device depending on any one of a read request and a write request using a feature supported by the Generic Attribute profile (GATT).

13. The IoT device interoperation method of claim 12, wherein performing the interoperation is configured to, when the IoT device interoperation apparatus performs a notify operation, change whether to activate notification setting of resource information which is included in the resource model DB and which corresponds to a notification resource URI included in a notify request message received from the OCF device.

14. The IoT device interoperation method of claim 13, wherein performing the interoperation is configured to:
when the IoT device interoperation apparatus receives a notify request message, retrieve an OCF resource URI and a BLE characteristic handle value, which correspond to the notification resource URI, from the mapping table, and
request the non-OCF BLE device to write a characteristic descriptor value using a feature supported by the Generic Attribute profile (GATT).

15. The IoT device interoperation method of claim 14, wherein performing the interoperation is configured such that the IoT device interoperation apparatus requests the non-OCF BLE device to write the characteristic descriptor value for changing whether to enable a notification bit of a characteristic value corresponding to the BLE characteristic handle value using a feature supported by the Generic Attribute profile (GATT).

16. The IoT device interoperation method of claim 15, wherein performing the interoperation is configured such that, when the characteristic value in which the notification bit is enabled is changed, the non-OCF BLE device notifies the IoT device interoperation apparatus of the changed characteristic value using a feature supported by the Generic Attribute profile (GATT).

17. The IoT device interoperation method of claim 16, wherein performing the interoperation is configured such that the IoT device interoperation apparatus updates resource information corresponding to the changed characteristic value in the resource model DB.

18. The IoT device interoperation method of claim 17, wherein performing the interoperation is configured such that the IoT device interoperation apparatus determines whether notification setting corresponding to the changed characteristic value has been activated.

19. The IoT device interoperation method of claim 18, wherein performing the interoperation is configured such that, if it is determined that the notification setting has been activated, the IoT device interoperation apparatus generates a response message including the updated resource information and sends the response message to the OCF device.

20. An Internet-of-Things (IoT) device interoperation apparatus, comprising:
an endpoint discovery unit for performing an endpoint discovery procedure between an Open Connectivity Foundation (OCF) device and a non-OCF Bluetooth Low Energy (BLE) device;
a resource manipulation unit for performing interoperation between the OCF device and the non-OCF BLE device by performing a resource manipulation procedure on the non-OCF BLE device through a Create, Retrieve, Update, Delete, and Notify (CRUDN) operation in response to a request from the OCF device; and
a resource model database (DB) unit for updating resource information in a resource model DB in response to a request from the endpoint discovery unit and/or the resource manipulation unit.
